(19) United States
(12) Patent Application Publication
(10) Pub. No.: US 2003/0208606 A1
(43) Pub. Date: Nov. 6, 2003

(54) Network isolation system and method

(76) Inventors: Larry Dean Maguire, Encinitas, CA (US); Victor Jay Castellucci, San Diego, CA (US)

Correspondence Address: Larry "Flack" MAGUIRE, P.O. Box 230942, Encinitas, CA, 92023-0942, US

(21) Appl. No.: 10/139,111

(22) Filed: May 4, 2002

(51) Int. Cl. G06F 15/16

(52) U.S. Cl. 709/227

(57) ABSTRACT

A system and method of selectively isolating a computerized device from a network may selectively decouple a network client from the network responsive to a signal transmitted from an appropriate sensor, for example. A switch or other selectively activated circuit element may disable data communications between the network client and other network nodes via the network, preventing network access to confidential data resident on the isolated network client.

### BACKGROUND

1. Field Of The Invention

Aspects of the present invention relate generally to networked computerized systems, and more particularly to a system and method of selectively isolating a computerized device from a network.

2. Description Of The Related Art

While networked computer systems have recently become effective and convenient platforms facilitating information exchange in both personal and commercial contexts, the nature of computer networks necessarily presents complications with respect to securing proprietary, confidential, privileged, or otherwise private data and information from unauthorized access. Many of the same factors which provide convenience and utility (i.e. continuous connectivity and global access, for example) also contribute to security risks in a computer network environment.

The recent proliferation of continuously coupled network access devices has accelerated efforts directed toward preventing unauthorized access to confidential information resident on individual networked computers. Coaxial cable modems and digital subscriber line (DSL) technology, for example, enjoy significant advantages over the previous generation of dial-up modem network connections; specifically, cable modem and DSL connections offer improved band width and data transfer rates as well as continuous, or “always-on,” connectivity for a network client The nature of such continuous network connections, however, also renders a computer implementing the technology continuously vulnerable to unauthorized access initiated from other network nodes or clients.

In a commercial or corporate context, wide area networks (WANs), local area networks (LANs), virtual private networks (VPNs), T1 or Ethernet connections, corporate intranets, and the like create significant security risks, since every network client is physically or logically coupled to the same network and shares much of the same data. Additionally, many corporate or private networks are coupled by one or more servers to the Internet; access to one server through the Internet may enable unimpeded access to all intranet data resident at every network node. Further, many corporate computers are never powered down, even when unattended for extended periods of time such as during evening hours, business holidays, and weekends. Consequently, proprietary corporate data and other information resident on these computers remain vulnerable to unauthorized access as long as the computers are receiving power and the network connection is established, i.e. continuously.

In a private or personal computer system context, the security risks are similar. Many personal computer (PC) users employ continuously coupled network access devices such as cable or DSL modems for connection to the Internet. A typical PC user may maintain bank account and tax return data, usernames, passwords and other codified information, personal documents, and other private records on such a PC; data and information resident on a PC or personal laptop computer may be misappropriated during an unauthorized access, or “hack,” via a continuously coupled network access device. Additionally, small scale home VPN or LAN network configurations may be implemented using Ethernet hubs or similar arrangements. Accordingly, unauthorized access to one PC (e.g. via the Internet through a network access device) may enable an unauthorized user to access data resident on every computer or device coupled to the home network.

Conventional network security methodologies are deficient, since hardware and software firewall strategies do not physically isolate a computer from the network to which it is coupled; in particular, if the firewall is breached, bi-directional data communication between the computer and another network client is still possible.

### BRIEF DESCRIPTION OF THE DRAWINGS

FIG. 1 is a simplified block diagram illustrating a network environment in which embodiments of a network isolation system and method may be implemented.

FIGS. 2A, 2B, and 2C are simplified block diagrams illustrating embodiments of a network isolation system.

FIGS. 3A and 3B are simplified block diagrams illustrating embodiments of a network isolation apparatus.

FIG. 4 is a simplified flow diagram illustrating the general operation of one embodiment of a method of selectively isolating a computerized device from a network.

### DETAILED DESCRIPTION

Embodiments of the present invention overcome the foregoing and various other shortcomings of conventional network security measures, providing a system and method of selectively isolating a computerized device from a network. In accordance with some embodiments, for example, a network client may be selectively decoupled from a network responsive to a signal transmitted from an appropriate sensor. A switch or other selectively activated circuit element may disable data communications between the network client and other network nodes via the network, preventing network access to confidential data.

In this context, therefore, it will be appreciated that the terms “isolating” or “decoupling” a device or network client from the network generally refer to disabling or disengaging communication between the device and the network, or to preventing access to data resident on the device from remote network nodes.

The foregoing and other aspects of various embodiments of the present invention will become more apparent upon examination of the following detailed description thereof in conjunction with the accompanying drawing figures.

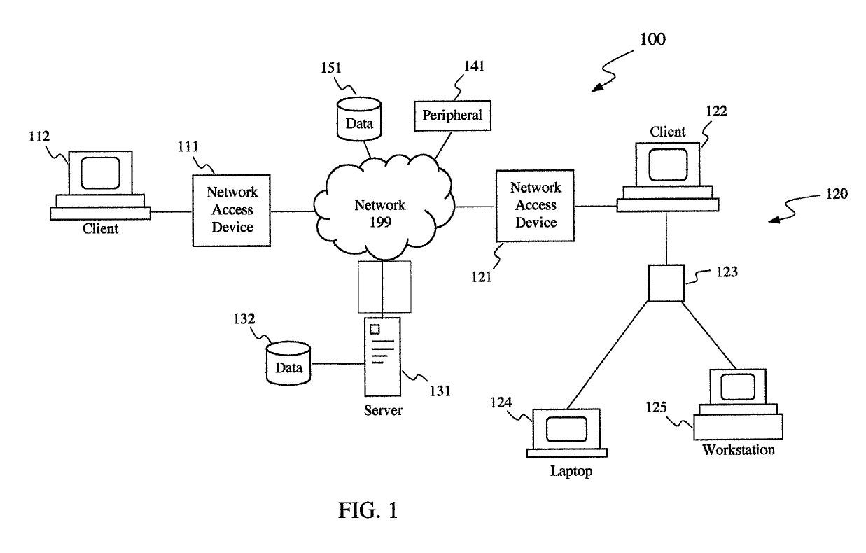

Turning now to the drawings, FIG. 1 is a simplified block diagram illustrating a network environment in which embodiments of a network isolation system and method may be implemented. In the exemplary FIG. 1 embodiment, network environment 100 generally comprises network clients 112 and 122 coupled to a network 199 via network access devices 111 and 121, respectively. As set forth in more detail below, various devices and computerized apparatus may be coupled to network 199; in that regard, computer server 131, peripheral device 141, and data storage medium 151 may be accessible from remote network clients 112 and 122. Those of skill in the art will appreciate that the arrangement illustrated in FIG. 1 is presented for illustrative purposes only, and that the several components depicted in FIG. 1 may be coupled via any number of additional networks (not shown) without inventive faculty.

As illustrated in FIG. 1 and described herein, network 199 may be any wide area network (WAN), metropolitan area network (MAN), local area network (LAN), virtual private network (VPN), home network, Integrated Services Digital Network (ISDN), or any other similar network arrangement (such as the Internet, for example) accommodating wire-line or wireless point-to-point, point-to-multipoint, or multipoint-to-multipoint data communications. In addition, network 199 may be configured in accordance with any topology generally known in the art, including star, ring, bus, or any combination thereof.

The data connection between components depicted in FIG. 1 may be implemented as a serial or parallel link Alternatively, the data connection may be any type generally known in the art for communicating or transmitting data across network 199. Examples of such networking connections and protocols include, but are not limited to: Transmission Control Protocol/Internetworking Protocol (TCP/IP); Ethernet; Fiber Distributed Data Interface (FDDI); ARCNET; token bus or token ring networks; Universal Serial Bus (USB) connections; Institute of Electrical and Electronics Engineers (IEEE) Standard 1394 (typically referred to as “FireWire”) connections; or any other networking technology generally known in the art or developed and operative in accordance with known principles.

Other types of data network interfaces and protocols are within the scope and contemplation of the present disclosure. In particular, network clients 112 and 122 described below may generally be configured to transmit data to, and to receive data from, other networked components using wireless data communication techniques, such as infrared (IR) or radio frequency (RF) signals, for example, or other forms of wireless communication. Accordingly, those of skill in the art will appreciate that network 199 may be implemented as an RF Personal Area Network (PAN) or a wireless LAN, for instance. In that regard, various suitable wireless communication standards and protocols such as Global System for Mobile (GSM), Code Division Multiple Access (CDMA), Time Division Multiple Access (TDMA), IEEE 802.11 for wireless LANs, Wireless Application Protocol (WAP), and the like are generally well known in the art and are continuously evolving.

It will be appreciated that the foregoing examples of networking technologies are illustrative only, and that the present disclosure is not intended to be limited with respect to the specific networking protocols or communication standards employed by any of the components illustrated and described herein with reference to the drawing figures.

In some embodiments, clients 112, 122 may be personal computers or workstations, personal digital assistants (PDAs), wireless telephones, or other network-enabled computing devices, electronic apparatus, or computerized systems. In operation, clients 112, 122 may execute software or other programming instructions encoded on computer-readable storage media, and additionally may communicate with each other and server 131, data storage medium 151, and peripheral device 141 via network access devices 111, 121, respectively. For example, client 112 may interrogate server 131 and request transmission of data maintained at data storage medium 132 coupled to, or accessible by, server 131. Additionally or alternatively, client 112 may interrogate client 122 and request transmission of data records or other information resident on computer readable media accessible by, or integrated with, client 122.

Examples of peripheral device 141 include, but are not limited to: servers; computers; workstations; terminals; input/output devices; laboratory equipment; printers; plotters; routers; bridges; cameras or video monitors; sensors; actuators; or any other network-enabled device known in the art. Peripheral device 141 may be coupled to network 199 directly, as illustrated in FIG. 1, or indirectly, for example, through server 131, such that the functionality or operational characteristics of device 141 may be influenced or controlled by hardware or software resident on server 131. As is generally known in the art, server 131 may be embodied or implemented in a single physical machine, for example, or in a plurality of distributed but cooperating physical machines.

Accordingly, the exemplary FIG. 1 network environment 100 enables access to information and data records resident at numerous networked devices via network 199. As noted above, the present disclosure contemplates additional networks associated with network environment 100. For example, network client 122 may be implemented as a node in a LAN or home network 120; in that regard, client 122 may be coupled to a networked laptop computer 124 and an additional PC or workstation 125 through an Ethernet hub, router, or similar hardware arrangement (reference numeral 123 in FIG. 1). Bi-directional data communication with client 122 through network access device 121 via network 199 may enable remote client 112 to access data records and other information resident at laptop 124 or workstation 125.

As illustrated in FIG. 1, home network 120 may generally operate in accordance with any of the data connections, interfaces, and protocols described above with reference to network 199, without limitation.

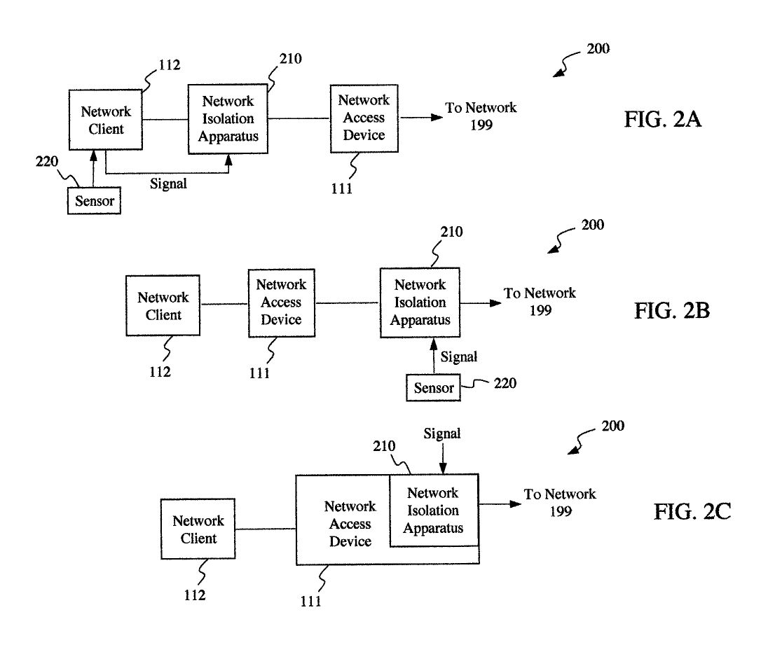

FIGS. 2A, 2B, and 2C are simplified block diagrams illustrating alternative embodiments of a network isolation system. As illustrated in FIGS. 2A-2C, a network isolation system 200 generally comprises a network client 112 coupled to a network via a network access device 111 substantially as described above with reference to FIG. 1. In some embodiments, access device 111 may be a continuously coupled device such as a cable or DSL modem; alternatively, access device 111 may be embodied in a network adapter card or other network interface hardware known in the art. Generally, the risk of an unauthorized hack or other security breach is greatest when access device 111 is continuously “on-line” (i.e. “coupled” with or “connected” to the network). In addition to any hardware or software firewall measures implemented at client 112, network isolation system 200 may further comprise a network isolation apparatus 210 operative selectively to decouple client 112 from the network responsive to an appropriate signal, for example, or to a predetermined or specified event.

Isolation apparatus 210 may be interposed between client 112 and access device 111 as indicated in FIG. 2A; alternatively, isolation apparatus 210 may be interposed between access device 111 and the network as indicated in FIG. 2B. Those of skill in the art will appreciate that various alternative implementations may be appropriate, depending upon overall system functionality and the operational characteristics of client 112, access device 111, or both. For example, various hardware elements and software code or firmware instruction sets embodying the functionality of isolation apparatus 210 may be integrated, in whole or in part, into access device 111, client 112, or some combination thereof. By way of example, FIG. 2C illustrates one embodiment integrating the functionality of isolation apparatus 210 with access device 111. By way of another example, access device 111 may be embodied as an integral or otherwise internal component of client 112, as is generally known in the art of incorporating peripheral equipment; accordingly, isolation apparatus 210 may alternatively be implemented as an external peripheral device coupled to the combination of client 112 and access device 111, or as an internal or integral component of the foregoing combination.

In operation, isolation apparatus 210 may decouple client 112 from the network, disabling data communications between client 112 and the network, in general, and other network nodes, in particular. In that regard, a switching component or other selectively activated circuit element may be implemented to interrupt or otherwise to disengage the communication circuit between client 112 and the network. As set forth generally above, such data communications may be interrupted (i.e. the communication connection may be decoupled) on either the network side or the client side of access device 111, depending upon overall system hardware characteristics and requirements.

As indicated in FIGS. 2A-2C, the functionality of isolation apparatus 210 may be responsive to a signal representative of a desired communication condition or configuration, i.e. enabled or disabled. In some embodiments described in detail below, a signal affecting operation of isolation apparatus 210 may be transmitted from an appropriate sensor 220 as illustrated in FIG. 2B, for example. Additionally or alternatively, a signal may be transmitted from client 112, which in turn may receive input from a sensor as illustrated in FIG. 2A; such a signal from client 112 may be transmitted in accordance with software code, for example, or responsive to depression of one or more keys or buttons on a keyboard, mouse, or other peripheral input device.

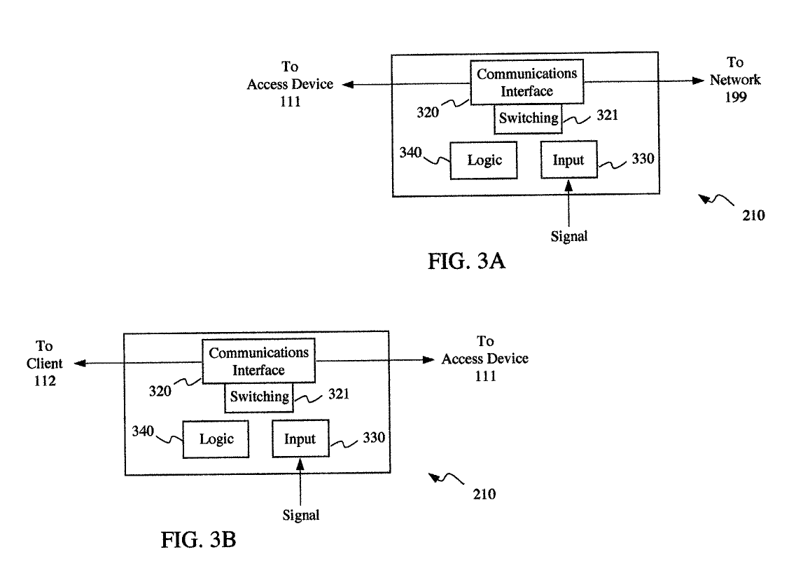

FIGS. 3A and 3B are simplified block diagrams illustrating alternative embodiments of a network isolation apparatus. The exemplary isolation apparatus 210 may generally correspond to that described above with reference to FIGS. 2A-2C, and may embody all of the functionality and operational characteristics set forth above. Accordingly, isolation apparatus 210 may be implemented on the network side (FIG. 3A) or the client side (FIG. 3B) of access device 111 as illustrated in FIGS. 2B and 2A, respectively.

Isolation apparatus 210 generally comprises a communications interface 320, selectively allowing or otherwise enabling data communication between a device (such as client 112 and access device 111) and a network, and a switching component 321. Additionally, isolation apparatus 210 may also include an input interface or port 330, though which signals may be received, and control electronics or logic component 340.

Communications interface 320 may function as a data communication conduit, and may comprise suitable hardware couplings, firmware instruction sets, software programming scripts, and the like appropriate for the hardware and network protocols required by the system (see FIGS. 2A-2C) in which isolation apparatus 210 is employed. For example, where access device 111 is a cable modem, interface 320 may comprise a coaxial cable jack and suitable firmware to enable coupling of isolation apparatus 210 with access device 111. Similarly, where network 199 is an Ethernet, for instance, interface 320 may comprise an Ethernet jack to facilitate the physical connection required for network access.

As illustrated in FIGS. 3A and 3B, switching component 321 (“switch”) is generally coupled to interface 320 and may be operative selectively to disable data communication between a device and the network substantially as described above. When an appropriate signal is received at input 330, for example, switch 321 may prevent communication of data through interface 320; in that regard, operation of switch 321 may have the same effect as physically disconnecting the communication cable (erg. Ethernet or coaxial cable, telephone cord, etc.) from access device 111 or client 112. Switch 321 may be embodied in a circuit element or other hardware component, for example, or in software programming code or firmware instruction sets; irrespective of its implementation, switch 321 may be configured to render data transfer or network communications through interface 320 inoperative responsive to a signal or to other acts or events.

In some embodiments, for example, switch 321 may be solely responsive to a signal received at input 330, such that logic 340 is not required (or may not be sophisticated). The signal may be generated by a sensor 220 (see FIG. 2B, for example) operative to detect the presence of a user at client 112, for instance; when the sensor determines that the user is no longer present at client 112, the sensor may transmit a signal to isolation apparatus 210 representative of the fact that client 112 has been left unattended. Responsive to such a signal received at input 330, switch 321 may disable data communication through interface 320, i.e. isolate access device or client from the network. Conversely, when the user returns (or a different user arrives), the sensor may detect such an arrival and transmit a signal to isolation apparatus 210 representative of the fact that client 112 is no longer unattended; responsive to such a signal, switch 321 may enable communication through interface 320.

Various sensors may be employed to generate appropriate signals for reception at input 330. For example, numerous heat sensitive (IR) monitoring or detection apparatus are generally known in the art; similarly, pressure sensitive sensors are also well known. Several types of motion sensors operative to detect electromagnetic energy in the ultrasonic, microwave, and other frequency ranges are generally known in the art and currently available, as are video and other optical sensors capable of capturing images and other video data Such sensors are typically employed to control lighting or temperature regulating equipment for homes and offices, and have many uses in both commercial and residential security applications. In the context of the present disclosure, such sensors may be implemented to monitor the vicinity of network client 112, to determine the presence of a user in a position to operate client 112, and to adjust the signal output in accordance with that determination.

A simple IR, motion, video, or optical sensor may be placed on, or attached to, a computer display or an input device (such as a keyboard or mouse, for example) to detect the presence of a user at client 112; additionally or alternatively, a pressure sensitive sensor may be placed on or attached to a chair or a keyboard, for example, such that presence of a user in the vicinity of client 112 may be ascertained. Those of skill in the art will appreciate that a sensor or other monitoring functionality may be integrated with isolation apparatus 210, access device 111, or client 112; in one such an embodiment (see FIG. 2A, for example), input 330 may be operative to receive signals only from client 112, as set forth in more detail below.

Signals affecting operation of switch 321 may be received at input 330 from one or more sensors directly, as described above; alternatively, such signals may be received from another system component such as access device 111 or client 112. In some embodiments, for example, one or more sensors such as described above may be coupled to, or integrated with, client 112; accordingly, communications control logic or software code resident at client 112 may determine whether to disable network communications based upon input from the sensors and a variety of other factors such as, inter alia, time of day, total network traffic, user input (through use of a keyboard or mouse, for example) at client 112, and processing loads at client 112. In accordance with such exemplary embodiments, signals generated by client 112 may instruct isolation apparatus 210 selectively to decouple client 112 from network 199 through interface 320.

As set forth above, operation of isolation apparatus 210 may be responsive to sensor input, to input from client 112, or a combination of both; accordingly, data communication through interface 320 may be interrupted automatically (i.e. when client 112 is left unattended for a predetermined period of time, for example, as determined by one or more sensors) or under software control based upon various programming scripts executed at client 112. In that regard, suitable programming code may enable a user at client 112 selectively to disable or otherwise to control network communications via an interactive user interface; in such an embodiment, software at client 112 may allow a user to select from one or more options which affect the configuration, operational parameters, or overall functionality of isolation apparatus 210. Accordingly, isolation apparatus 210 may further comprise logic component 340, which may be embodied in a programmable logic controller (PLC), a micro-controller, or a micro-computer generally known in the art; additionally or alternatively, logic 340 may incorporate reconfigurable firmware instructions sets or software code. In some applications where flexibility or adaptability is desired, logic 340 may readily be implemented as a removable or replaceable chip or card.

In operation, logic 340 may generally configure isolation apparatus 210 to operate in accordance with predetermined functional characteristics. As noted above, logic 340 may be selectively reconfigured or replaced to accommodate changing system requirements or increasingly complicated communications control functions. By way of example, in conjunction with signals received at input 330, logic 340 may configure isolation apparatus 210 to delay operation of switch 321 for a predetermined period of time, for instance, such that network communications are disengaged or reestablished after a timer lapses following a specified or predetermined event. Additionally or alternatively, logic 340 may be programmed such that isolation apparatus 210 is configured to function in accordance with days of the week or specific times of day, for example; in such an embodiment, data transfer through interface 320 may be rendered inoperative (notwithstanding the nature or timing of signals received at input 330) during particular periods of time or under other circumstances specified by configurable logic 340 or communications control intelligence at client 112.

In accordance with another embodiment of isolation apparatus 210 configured and operative to work in conjunction with conventional hardware or software firewall technology, logic 340 may be configured to receive signals generated by or transmitted from one or more components of the firewall implementation. Accordingly, when the firewall detects an attempted unauthorized access, for example, logic 340 may be apprised by an appropriate signal and, responsive thereto, cause switching component 321 to disable data communications accordingly. Alternatively, some aspects of firewall “hack” detection functionality may be incorporated into logic 340, i.e. logic 340 itself may incorporate sufficient intelligence to detect hack attempts without relying upon signals from an external firewall arrangement. As noted above, detected attempts at unauthorized access from a remote network node may trigger switching component 321 to isolate a device from the network.

It will be appreciated that the sophistication of logic 340, its interoperation with software code at client 112, or both, may also be selectively adjusted in accordance with the capabilities and operability of the various sensors and associated monitoring functionality employed by a network isolation system 200. For example, in some embodiments incorporating optical sensors and video identification systems, logic 340, client 112, a network server to which client 112 is coupled, or some combination of these components may be configured to enable switch 321 to operate as a function of the identity of the user present at client 112; accordingly, network access may be selectively enabled depending, for example, upon an authorization status for a particular user and a confirmation (based upon video and optical data, for instance) of that particular user's identity.

Isolation apparatus 210 may further comprise a power supply (not shown in FIGS. 3A and 3B) providing operating power to switching component 321, logic 340 (if implemented), and interface 320 (if necessary). Power may be provided by one or more primary or secondary battery power sources, for example, or by an alternating current (AC) power supply and transformer (if required) as is generally known in the art. Alternatively, power required to operate the various components of isolation apparatus 210 may be drawn from client 112 or access device 111.

In accordance with the foregoing, it will be appreciated that system 200 and isolation apparatus 210 are susceptible of various alterations and modifications providing additional utility and flexibility. For example, a component of system 200, such as isolation apparatus 210, may further comprise an over-ride switching mechanism (not shown in FIGS. 2A-C and 3A-B) which may be manually operated, for example, or operative under software control as described above. In a manual embodiment, for instance, a switch, button, knob, lever, or other suitable mechanism coupled to switching component 321 or to logic 340 may be physically manipulated selectively to enable or to disable data communications through interface 320 irrespective of the presence of a user or other communication parameters. Such over-ride, or “kill switch,” functionality may allow a user to disable all data communications as desired, notwithstanding any factors which would otherwise cause or allow switch 321 to enable network access.

Additionally, a component of system 200, such as isolation apparatus 210, may further comprise a communication status indicator (not shown in FIGS. 2A-C and 3A-B) providing a visual or aural indication of the status of communication through interface 320. In some embodiments, for example, one or more light emitting diodes (LEDs) or liquid crystal display (LCD) elements may be implemented to provide a visual representation of the status of data communications through interface 320. By way of example, illumination of a particular type of LED (a red LED, for instance) may indicate that network communications are enabled and that access to data from a remote network node is possible, whereas illumination of a second type of LED (a green LED, for example) may indicate network isolation. Similarly, a steady illumination may indicate that communications are enabled, while a flashing LED may indicate that communications are disabled. While only a few examples are provided herein, it will be appreciated that various methods of providing such indications are known in the art.

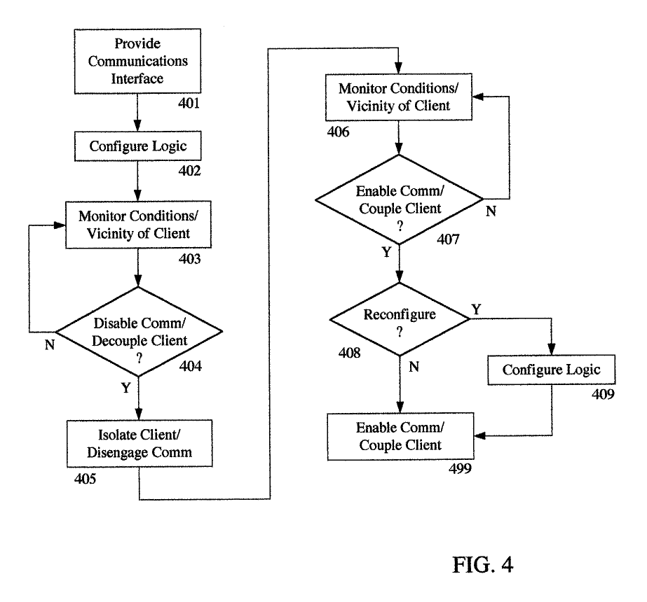

FIG. 4 is a simplified flow diagram illustrating the general operation of one embodiment of a method of selectively isolating a computerized device from a network.

As represented in FIG. 4, a method of isolating a computerized device such as a network client from a network may generally comprise providing a communications interface (block 401) substantially as set forth in detail above. Such an interface may operate as a communication conduit, selectively allowing data transfer or communications between a network and a client coupled to the network. In some embodiments, one or more communications logic components may be configured as indicated at block 402. In many applications, logic may be embodied in hardware, for example (such as a PLC), or encoded in software scripts or instruction sets; as set forth in detail above, logic may be integrated with an isolation apparatus or a network client, and may be reconfigurable or removable to provide flexibility with respect to system requirements. A logic component may configure operational parameters and control the functionality of an isolation apparatus as described above with reference to FIGS. 3A and 3B.

As indicated at block 403, the vicinity of the network client may be monitored for activity indicative of the presence of a user in a position or location which would enable operation of the client; other conditions or parameters may be monitored depending upon the configuration and programming instructions provided to isolation logic at block 402. As set forth above, the current time and day of the week, among other parameters, may be monitored by logic such that the functionality of an isolation apparatus may be selectively controlled in accordance with predetermined system specifications.

Data communication may be selectively disabled as indicated at block 405. As described in detail above, disabling communication between a network client and the network (i.e. decoupling or isolating the client from the network) may be responsive to the monitoring executed at block 403; in that regard, a determination may be made as indicated at decision block 404. For example, where a sensor signal indicates that no user is present at a network client, communications control may pass from decision block 404 to block 405 and data communication through the communications interface may be disabled so as to isolate the client Conversely, when a user is present at the network client, or other conditions specified by logic have not been satisfied, for example, control may loop back to block 403 and monitoring may continue.

As set forth above with reference to various embodiments, monitoring at block 403 and the determination to disable communications at decision block 404 may be based upon a sensor signal, various communications logic parameters, or a combination of both. In one exemplary embodiment, a timer may be set when a sensor signal is received at the isolation apparatus; operation of the isolation apparatus (i.e. disengaging data communication between the client and the network) may be delayed until the timer lapses, for example, or otherwise in accordance with logic or other communication control intelligence.

Similarly, a method of selectively disabling network communications may monitor the vicinity of a network client and other parameters (block 406) and make a determination (decision block 407) that data communications may again be enabled. Such a resumption or reestablishment of communication between a client and the network may be based upon, among other things, the presence of a user at the client, the occurrence of one or more specified events, or a combination of both. Where logic is configured to isolate a network client during evening hours, for example, the client may be coupled to the network and data communications enabled at a specified time in the morning; as an additional security feature, network communications may remain inoperative (even after the specified time of day) until a user is present in a position to operate the network client. As noted above, such functionality may readily be implemented with communications logic operating in conjunction with IR, optical, motion, or pressure sensitive sensor signals, for example.

Where all conditions necessary for enabling network communications have not been satisfied as determined at decision block 407, monitoring may continue at block 406; alternatively, when appropriate conditions have been satisfied, the client or other device may be coupled to the network and data communication may be enabled as indicated at block 499. In some embodiments, logic may be reconfigured as indicated at block 409 and as set forth in detail above. Accordingly, it may be desirable to ascertain whether logic is to be reconfigured (as indicated at decision block 408) prior to enabling data communications (block 499) through an isolation apparatus. Alternatively, in some dynamically reconfigurable embodiments, logic may be altered or reprogrammed at any time; it will be appreciated that this feature may be facilitated by implementations integrating some or all of the functionality of an isolation apparatus (including logic) with a network client.

Aspects of the present invention have been illustrated and described in detail with reference to particular embodiments by way of example only, and not by way of limitation. It will be appreciated that various modifications and alterations may be made to the exemplary embodiments without departing from the scope and contemplation of the present disclosure. It is intended, therefore, that the invention be considered as limited only by the scope of the appended claims.

What is claimed is:

1. A network isolation apparatus comprising:
a communications interface selectively allowing data communication between a device and a network; and
a switching component coupled to said communications interface and operative selectively to isolate said device from said network at said communications interface.

2. The apparatus of claim 1 further comprising an input port operative to receive a signal affecting operation of said switching component.

3. The apparatus of claim 1 further comprising a logic component operative to configure said apparatus in accordance with communication control parameters.

4. The apparatus of claim 1 further comprising a sensor operative to transmit a signal affecting operation of said switching component.

5. The apparatus of claim 2 wherein said switching component is responsive to a signal transmitted from a sensor.

6. The apparatus of claim 2 wherein said switching component is responsive to a signal transmitted from said device.

7. The apparatus of claim 6 wherein said signal is generated by communications control logic resident at said device.

8. The apparatus of claim 4 wherein said sensor is an infra-red sensor.

9. The apparatus of claim 4 wherein said sensor is a pressure sensitive sensor.

10. The apparatus of claim 4 wherein said sensor is an optical sensor.

11. The apparatus of claim 4 wherein said sensor is a motion sensor.

12. The apparatus of claim 1 wherein said switching component is operative selectively to disable said data communication.

13. A network isolation system comprising
a network client;
an access device coupling said network client to a network; and
an isolation apparatus operative selectively to isolate said network client from said network.

14. The system of claim 13 further comprising a sensor operative to transmit a signal to said isolation apparatus and wherein said isolation apparatus is responsive to said signal.

15. The system of claim 14 wherein said sensor is an infra-red sensor.

16. The system of claim 14 wherein said sensor is a pressure sensitive sensor.

17. The system of claim 14 wherein said sensor is an optical sensor.

18. The system of claim 14 wherein said sensor is a motion sensor.

19. The system of claim 13 wherein said isolation apparatus is responsive to a control signal transmitted from said network client.

20. The system of claim 19 wherein said control signal is generated by communications control logic resident at said network client.

21. The system of claim 13 wherein said isolation apparatus is configured in accordance with communication control parameters.

22. The system of claim 13 wherein said isolation apparatus comprises a switching component operative selectively to decouple said network client from said network.

23. A method of isolating a computerized device from a network; said method comprising:
providing a communication interface selectively enabling data communication between said device and said network;
monitoring communication control parameters; and
selectively disabling said data communication responsive to said monitoring.

24. The method of claim 23 wherein said monitoring comprises determining whether a user is present in the vicinity of said device.

25. The method of claim 24 wherein said determining comprises receiving a signal from a sensor.

26. The method of claim 24 wherein said monitoring further comprises utilizing communication control logic.

27. The method of claim 26 wherein said selectively disabling comprises delaying said disabling in accordance with said logic.

28. The method of claim 23 wherein said selectively disabling comprises preventing access of data resident at said device from a remote network node.

29. A network isolation apparatus comprising:
a communications interface selectively allowing data communication between a device and a network; and
isolation means for selectively isolating said device from said network.

30. The apparatus of claim 29 wherein said isolation means comprises:
a switching component operative to disable said data communication; and
an input port operative to receive a signal affecting operation of said switching component.

31. The apparatus of claim 30 further comprising a logic component operative to configure said isolation means in accordance with communication control parameters.

32. The apparatus of claim 30 wherein said input port is coupled to a sensor and wherein said switching component is responsive to a signal transmitted from said sensor.

33. The apparatus of claim 30 wherein said input port is coupled to said device and wherein said switching component is responsive to a signal transmitted from said device.

34. The apparatus of claim 33 wherein said signal is generated by communications control logic resident at said device.

35. The apparatus of claim 32 wherein said sensor is an infra-red sensor.

36. The apparatus of claim 32 wherein said sensor is a pressure sensitive sensor.

37. The apparatus of claim 32 wherein said sensor is an optical sensor.

38. The apparatus of claim 32 wherein said sensor is a motion sensor.
